(19) United States
(12) Patent Application Publication
(10) Pub. No.: US 2015/0293604 A1
(43) Pub. Date: Oct. 15, 2015

(54) TYPING APPARATUSES, SYSTEMS, AND METHODS

(71) Applicants: Francisco Javier Fernandez, Portland, OR (US); Bradley Brad Jackson, Hilsboro, OR (US); Ramune Nagisetty, Portland, OR (US); Srinivas Sundaravaradan, Hillsboro, OR (US)

(72) Inventors: Francisco Javier Fernandez, Portland, OR (US); Bradley Brad Jackson, Hilsboro, OR (US); Ramune Nagisetty, Portland, OR (US); Srinivas Sundaravaradan, Hillsboro, OR (US)

(21) Appl. No.: 14/353,824

(22) PCT Filed: Dec. 16, 2013
(86) PCT No.: PCT/US2013/075340

§ 371 Date: Apr. 24, 2014

(51) Int. Cl. G06F 3/02; G06F 3/041

(52) U.S. Cl. CPC G06F 3/0219; G06F 3/041

(57) ABSTRACT

Generally discussed herein are systems and apparatuses that are configured for typing. Also discussed herein are techniques of making and using the systems and apparatuses. According to an example a technique may include assigning a particular set of characters of a plurality of disjoint sets of characters to each of a plurality of character buttons, projecting the assigned set of characters on each respective character button on a display, receiving an input from a particular one of the plurality of character buttons, and transmitting a signal representative of one of the characters in the particular set of characters of the plurality of disjoint sets of characters assigned to the particular one of the plurality of character buttons in response to the input being received.

### TECHNICAL FIELD

Examples generally relate to typing apparatuses, keypads, displays, or on screen keyboards and more specifically to devices that may be configured for single-hand typing.

### TECHNICAL BACKGROUND

Keyboards are convenient tools for sending communication signals to a processor or other computing components. Keyboards have evolved from typewriter style keyboards to keyboards implemented on touch screens. Keyboards may come in many forms, such as a QWERTY keyboard format or a telephone keypad format.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example of a typing configuration and a text renderer.

FIG. 2 shows another example of a typing configuration and a text renderer.

FIGS. 3A, 3B, 3C, and 3D show an example of a progression of views of typing configurations.

FIGS. 4A, 4B, 4C, and 4D show an example of a progression of views of typing configurations.

FIG. 5 shows an example of a chart that includes examples of actions and a corresponding example of a button activations combination that may be used to cause the action to be performed on a display.

FIG. 6 shows an example of a typing configuration coupled to processing circuitry.

FIG. 7 shows an example of a technique of using a typing configuration.

FIG. 8 illustrates a block diagram of an example of a machine upon which any of one or more techniques (e.g., methods) discussed herein may be performed.

### DESCRIPTION OF EMBODIMENTS

Conventional QWERTY keyboards are difficult, if not practically impossible, to display on a device with a sufficiently small display area. Conventional QWERTY keyboards and telephone keyboards are difficult to implement in an area with a sufficiently restricted size. The buttons may be sufficiently small so as to make contacting a specific button difficult.

A typing configuration designed to be implemented in a small size, such as on a cellphone, may overload the number keys to allow letters or other characters to be input. For example, the number “2” key may be used to input “2”, “A”, “B”, or “C” characters. To input a “B”, the user may select the particular button three times in short succession. To input a “C” character, the user may select the particular key four times in short succession. In this way, the entire alphabet, plus additional characters, may be mapped onto a typing configuration. The typing configuration may be configured in a telephone keypad layout with numbers 0-9 and “*” and “#” characters. This is a convenient layout for representing keys in a small surface area, such as on a mobile phone. While this may work well for a mobile phone, for devices that are even smaller, such as a wristwatch, the twelve buttons may take up too much space.

In one or more examples, rather than featuring twelve buttons as in the telephone keypad, the typing configurations described herein may display only a subset of the twelve buttons at a single time. The typing configurations may also display one or more control buttons configured to change the displayed subset of twelve buttons. For example, three buttons for selecting alphanumeric characters may be displayed along with one or more control buttons, where the control buttons may select a next and a previous group of three buttons. In addition, the control buttons may perform other control actions that are possible on a conventional QWERTY keyboard, such as space, caps lock, backspace, tab, shift, control, insert, delete, move cursor up, move cursor down, move cursor left, move cursor right, and return, among others.

The typing configurations may provide a convenient typing configuration for instances where a user wants to use a single hand for typing or only has a single hand available for typing. The typing configuration may be relatively small such that a space allocated for the typing configuration may be relatively small. The size of the typing configurations may allow the typing configurations to be implemented on a touch screen of a wristband, a display on a phone (e.g., a Smartphone), a pair of glasses (e.g., on a band of the glasses), or other mobile device. Any of the typing configurations discussed herein may be implemented as a physical keyboard or may be implemented on a touch screen.

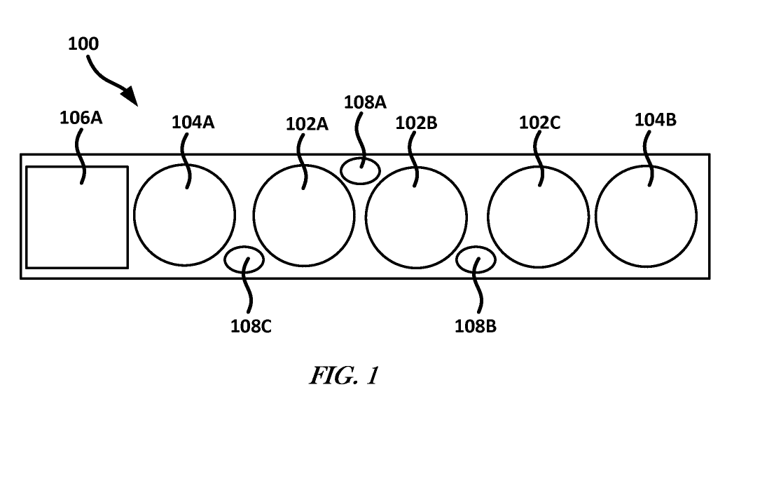

FIG. 1 shows an example of a typing configuration 100 and a text renderer. The typing configuration 100 may include one or more character buttons 102A, 102B, and 102C, one or more control buttons 104A or 104B, one or more displays 106A (e.g., text renderers), and one or more orientation bumps 108A, 108B, or 108C. The typing configuration 100, the display 106A, the character buttons 102A-C, or the control buttons 104A-B may be flexible, such as to be configured to bend or to fit comfortably on a wrist band, watch, or other curved surface.

In one or more examples, the display 106A, character buttons 102A-C, and control buttons 104A-B may be displayed on the same screen. In these examples, the screen may be a touchscreen display.

The character buttons 102A, 102B, and 102C may be coupled to the display 106A, such as through a wired or wireless electrical coupling. The character buttons 102A-C may be configured to cause a character (e.g., alphanumeric character, symbol, or other character) to be displayed on a display, such as display 106A. The character may be displayed on the display in response to the character button 102A-C being activated. While FIG. 1 shows the display as a part of the typing configuration 100, the display 106A may be separate from the typing configuration 100. For example, the typing configuration 100 may be wirelessly electrically coupled to a remote display so as to cause characters or other actions typed into the character buttons 102A-C or control buttons 104A-B to alter what is displayed on the remote display.

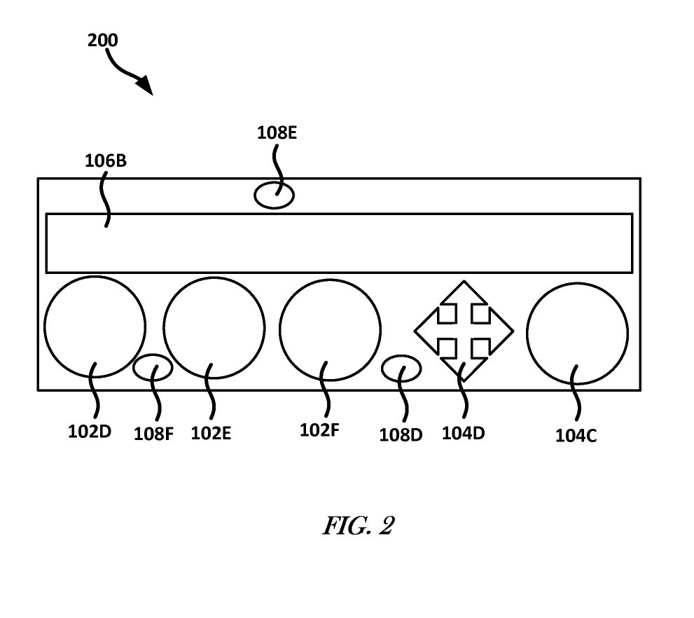

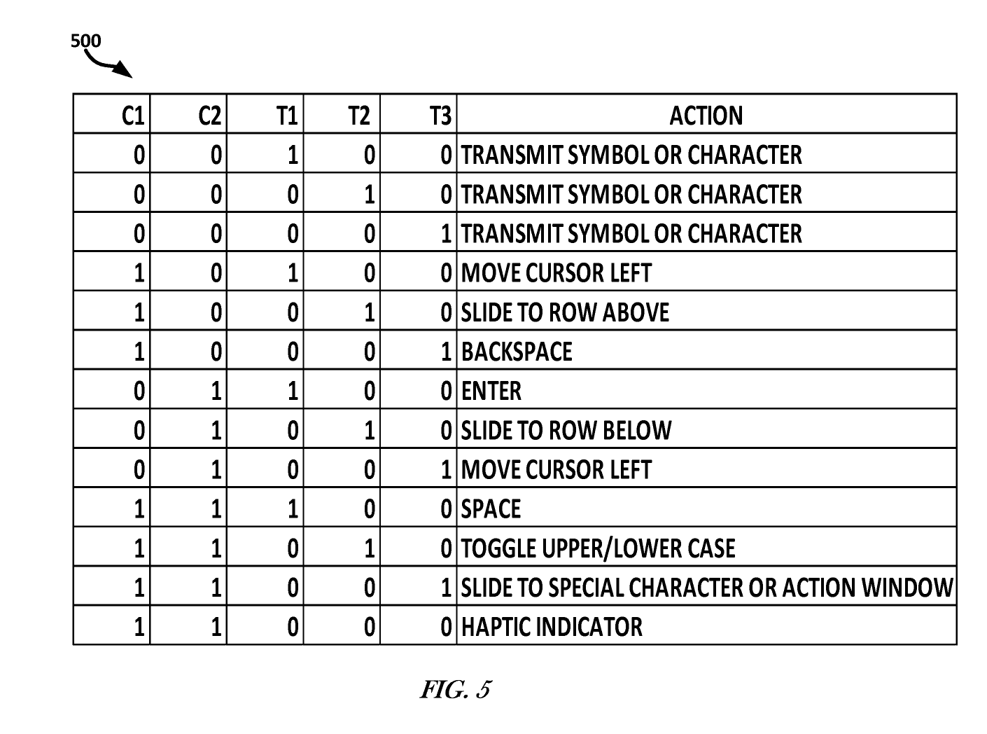

The control buttons 104A-B may perform many functions. For example, the control buttons 104A-B may change the particular characters that are assigned to the particular character buttons 102A-C. The control button 104A-B may be configured to change the characters that may be displayed in response to the character button 102A-C being activated. The control buttons 104A-B, when activated singularly or in combination with the other control button 104A-B or one or more of the character buttons 102A-C, may cause an action to occur, such as a QWERTY keyboard action, or the characters that may be displayed in response to the character button 102A-C being activated, or an action performed by a device included in the wrist band or watch to occur (e.g., a light turning on, a motor creating haptic vibrations, a backlight illuminating, among other device actions). For example, the control buttons 104A-B may be configured to alter where a cursor (e.g., a visible or invisible cursor) is on the display 106A. More details about the functionality that may be provided by the control button 104A-B are described herein, such as in the description of FIGS. 2 and 5.

The control buttons 104A-B and the character buttons 102A-C may be configured in a row, such as a single row, such as shown in FIG. 1. The control buttons 104A-B may be located such that the control buttons 104A-B are not located next to each other and there is one (e.g., at most one) character button 102A-C directly adjacent to the respective control button 104A-B. The control buttons 104A-B may be situated such that there is one control button 104A-B on each side of the row of buttons, such as shown in FIG. 1. One of ordinary skill in the art, having the benefit of Applicants' disclosure, will appreciate that the exact ordering or orientation of the buttons may be changed.

The display 106A may be a Liquid Crystal Display (LCD), Light Emitting Diode (LED), Electroluminescent Display (ELD), or a Plasma Display Panel (PDP), among others. The display 106A may be configured to display a character corresponding to a character button 102A-C being activated. The display 106A may be configured to show a cursor thereon. The cursor may indicate to a user where the next character typed on the typing configuration 100 will appear. Using the location of the cursor on the display 106A, a user may get a better idea of what will be displayed on the display 106A prior to a user activating the character button 102A-C or the control button 104A-B.

The display 106A may be situated in line with the character buttons 102A-C or the control button 104A, such as shown in FIG. 1. The display 106A may indicate the particular ‘row’ of character sets (e.g., subsets of characters) the typing configuration 100 may currently cause to be displayed. Such an indicator may help a user since the user would not have to lift the fingers off the typing configuration 100 to determine visually which row of characters may be caused to be displayed. Such an indicator may include a number or letter indicating which row of a telephone keypad the typing configuration 100 is currently configured to replicate.

The bumps 108A-C may indicate to a user where their finger(s) is relative to the character buttons 102A-C, the control button 104A-B, or the display 106A. The bumps 108A-C may be raised bumps, indentations, or a combination thereof. The bumps 108A-C may be located anywhere on the typing configuration 100 and may be included in any number from zero and above.

FIG. 2 shows another example of a typing configuration 200 and a text renderer. The typing configuration 200 may include one or more character buttons 102D-F, one or more control buttons 104C or 104D, a display 106B, or one or more bumps 108D-F. The items (e.g., 102D-F, 104B-C, 106B, or 108D-F) of the typing configuration 200 may be substantially similar to the items of the typing configuration 100 that have the same reference number but a different letter suffix.

The control button 104D may be configured to be activated by a user swiping a finger vertically or horizontally across the control button 104D. The control button 104D may be configured to cause an action to occur in response to a user activating the control button 104D. A user may cause an action to be performed on the display 106B by activating the control button 104C or 104D singularly or in combination with another control button 104C or 104D or one or more character buttons 102D-F.

The display 106B may be situated above the character buttons 102D-F and control buttons 104C-D, such as to be situated out of line with the character buttons 102D-F and the control buttons 104C-D, such as shown in FIG. 2.

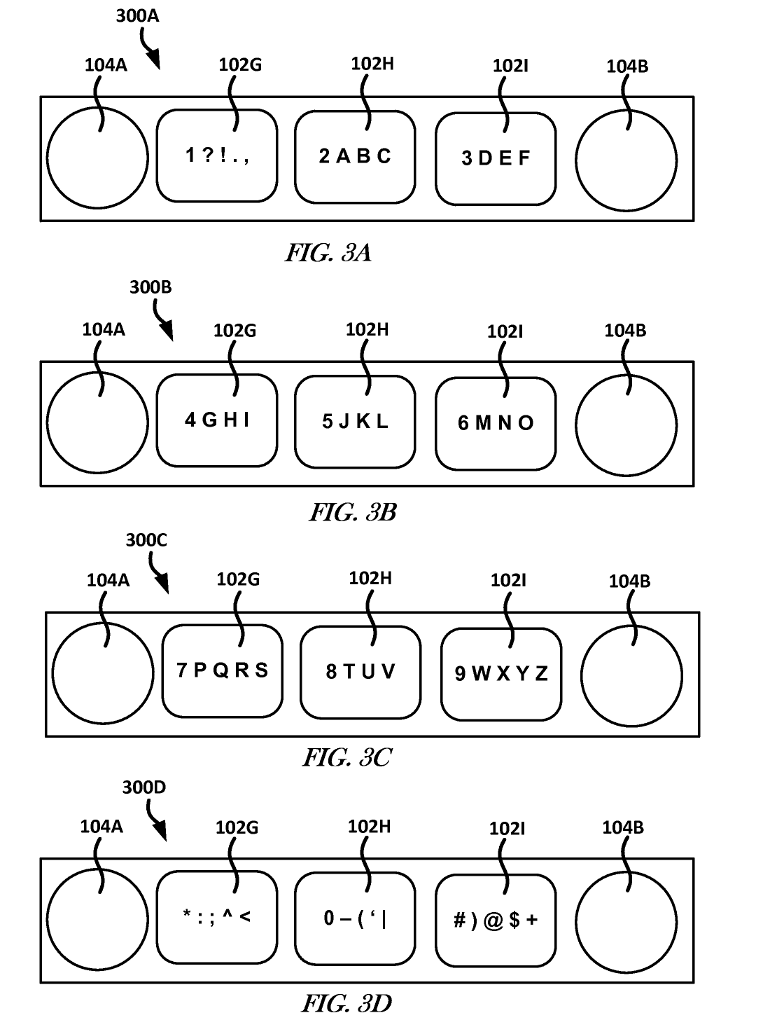

FIGS. 3A-D show an example of a progression of character buttons 102G, 102H, and 102I. FIG. 3A shows an example of a typing configuration 300A with the characters (“1”, “?”, “!”, “.”, “,”, “2”, “A”, “B”, “C”, “3”, “D”, “E”, “F”) that may be caused to appear on the display 106A-B, such as in response to a respective character button 102G-I being activated. The character buttons 102G-I may each be associated with a respective set of characters. For example, character button 102G may be associated with the set of characters (“1”, “?”, “!”, “.”, and “,”); character button 102H may be associated with the set of characters (“2”, “A”, “B”, “C”); and character button 102I may be associated with the set of characters (“3”, “D”, “E”, “F”), such as shown in FIG. 3A.

The character buttons 102G-I may function or operate in a manner similar to that of a telephone keypad button. That is, if character button 102G is activated once, such as in a specified period of time or only once before another character button 102H-I or control button 104A-B is activated, the character “1” may be caused to be displayed on the display 106A-B; if character button 102G is activated twice without a specified period of time elapsing between activations the character “?” may be caused to be displayed; if character button 102G is activated three times without a specified period of time elapsing between activations, the character “!” may be caused to be displayed; if the character button 102G is activated four times without a specified period of time elapsing between activations, the character “.” may be caused to be displayed; and if the character button 102G is activated five times without a specified period of time elapsing between activations, the character “;” may be caused to be displayed. If character button 102G is activated six time without a specified period of time elapsing between activations, the character “1” may be caused to be displayed, and so on (e.g., the character buttons 102G-I may be configured to wrap back to the beginning of the set of characters in response to the number of activations exceeding the number of characters in the set that may be caused to be displayed by the character button 102G (in the case of character button 102G in FIG. 3A, the number of characters in the set of characters is five)). Similarly, character buttons 102H-I may be configured to cause different characters to be displayed as a function of how many times the respective button is activated without a specified period of time elapsing between activations. The specified period of time can be user-configurable, manufacturer specified, or Operating System (OS) specified. The specified period of time can be between about ten milliseconds and up to about five seconds. The specified period of time can be about a half a second in one or more embodiments.

FIG. 3B shows the typing configuration 300B, which is a view of the typing configuration 300A after the control button 104A-D is pressed. Conceptually, the character sets that include “1”, “2”, “3”, are above the sets that include “4”, “5”, “6”, respectively, and below sets of miscellaneous characters, such as those character sets shown in FIG. 3D. When (e.g., after or around the time) the control button 104B is pressed, the characters displayed may advance to the characters displayed in the next FIG. (e.g., if FIG. 3A is displayed, pressing the control button 104B may advance the displayed characters to those characters shown in FIG. 3B; if FIG. 3B is displayed, pressing the control button 104B may advance the displayed characters to those characters shown in FIG. 3C, etc.) If FIG. 3D is being displayed and the control button 104B is pressed, the display may loop around to display the characters as shown in FIG. 3A.

Similarly, when another control button 104A-D is pressed, the characters displayed may advance to the characters displayed in the previous FIG. (e.g., if FIG. 3D is displayed, pressing the control button 104A may advance the displayed characters to those characters shown in FIG. 3C; if FIG. 3C is displayed, pressing the control button 104A may advance the displayed characters to those characters shown in FIG. 3B, etc.) If FIG. 3A is being displayed and the control button 104A is pressed, the display may loop around to display the characters as shown in FIG. 3D.

The move or slide row up or down action may be generated by activating a control button 104A-B, such as in combination with another control button 104A-B or one or more character buttons 102G-I. Examples of actions and corresponding example button activation combinations that may be used to cause the actions are shown in FIG. 5.

While FIGS. 3A-D show the character sets displayed or projected on the character buttons 102G-I, the characters (e.g., character sets) may not be displayed or projected on the character buttons 102G-I. Also, the control buttons 104A-B may include symbolic or textual representations of actions that the control button 104A-B may be used perform projected or displayed thereon. The character sets may indicate the button combinations required to cause one or more actions to occur or may include textual representations of actions that may be caused to occur in response to activating the control button 104A-B.

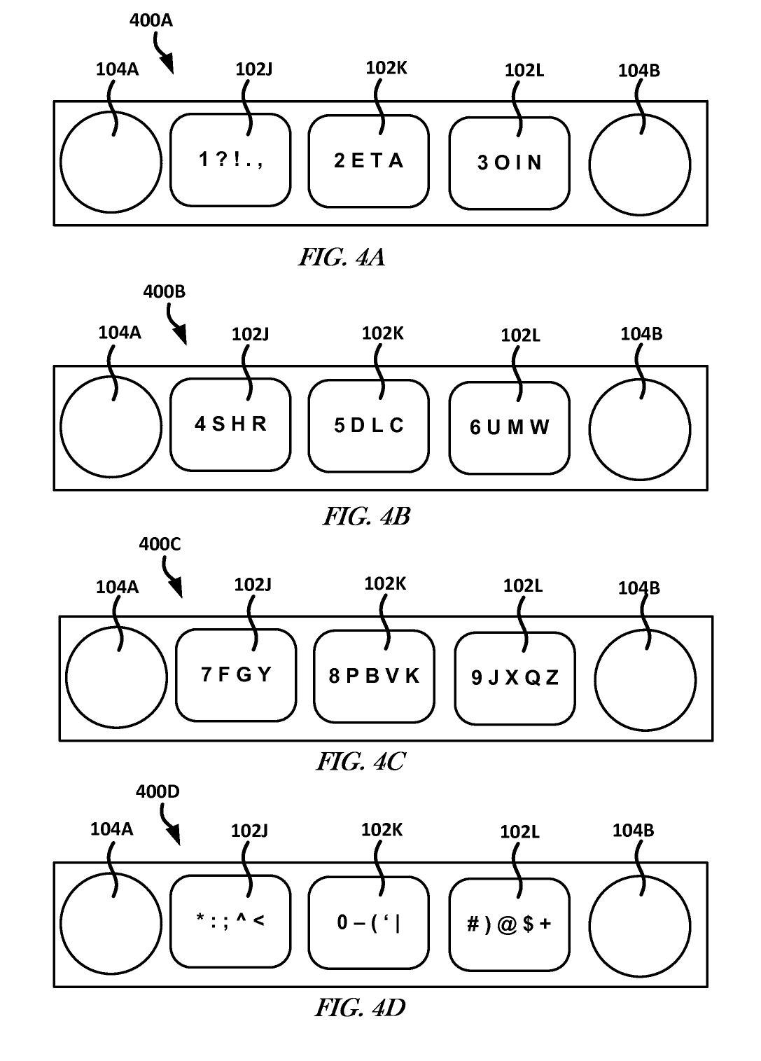

FIGS. 4A, 4B, 4C, and 4D illustrate a progression of views of typing configurations 400A, 400B, 400C, and 400D, respectively. Typing configurations 400A-D may be substantially similar to the typing configurations 300A-D, respectively, with the characters that may be caused to be displayed in response to activating the character buttons 102J, 102K, 102L being different than the characters that may be caused to be displayed in response to activating the character buttons 102G-I. The characters may be organized according to a heuristic so that the order of the characters is not necessarily the same as that of a telephone keypad. Examples of heuristics may include numerical order, alphabetical order, probability that the character will be typed, random order, or other heuristic. The example shown in FIGS. 4A-4D uses a heuristic that is a combination of numerical order, the letters in probabilistic order from letter most likely to be displayed to the letter least likely to be displayed (assuming English language is being used), and also including characters in a random order.

Each of typing configurations 300A-D and 400A-D are configured as a subset of the keys of a telephone keypad (for example, a single row). The control button 104A-B may change which individual row of the telephone keypad the typing configuration 300A-D or 400A-D is configured as.

FIG. 5 shows an example of a chart 500 that includes examples of actions and a corresponding example of a button activation combination that may be used to cause the action to be performed on the display 106A-B. C1 and C2 may correspond to two different control buttons 104A-D and T1, T2, and T3 may correspond to three of the character buttons 102A-L. A “1” in the chart 500 indicates that the respective button corresponding to the column the “1” is in is activated, and “0” in the chart 500 indicates that the respective button corresponding to the column the “0” is in is deactivated.

Thus, in the example shown in FIG. 5, if C1, C2, and T1 are activated and T2 and T3 are deactivated, a space may be caused to be displayed on the display 106A-B. If C1 and T2 are activated and C2, T1, and T3 are deactivated, the characters that may be caused to be displayed by activating a character button 102A-L may be caused to slide to the row above (such as is described in more detail with regard to FIGS. 3A-3D and 4A-4D). If C1, C2, and T3 are activated and T1 and T2 are deactivated, the display may be caused to show a selection of special characters (e.g., characters that may not be displayed by activating a character button 102A-L) or an action window (e.g., a window, such as a window similar to the chart 500, which details the actions that may be caused to occur using the buttons on the typing configuration).

If C1 and C2 are activated and T1, T2, and T3 are deactivated then a haptic device (e.g., a motor) may be activated. The haptic vibrations may be used so as to help a blind person use the typing configuration. The haptic device may indicate, such as through a number of vibrations, which row of characters the typing configuration is currently configured as. For example, the haptic device may vibrate once if the character set is currently as shown in typing configuration 300A of FIG. 3A (e.g., the first row), twice if the character sets are currently as shown in typing configuration 300B of FIG. 3B (e.g., the second row); three times if the character sets are currently as shown in typing configuration 300C of FIG. 3C (e.g., the third row); or four times if the character sets are currently as shown in typing configuration 300D of FIG. 3D (e.g., the first row). Other actions may be caused to be performed, such as the QWERTY actions discussed previously, the previous character that was last input or displayed may be displayed again (in duplicate), a character may be caused to be displayed or the cursor may be caused to move one position to the left, right, up, or down, among others.

Other combinations of buttons (e.g., control buttons 104A-D or character buttons 102A-L) may be used to cause an action to occur. For example, activating C1 while the remaining buttons are deactivated may cause the row to move up or down, or some other action to occur.

When used in connection with a wristband or other mobile device, a watch featuring a wraparound (e.g., flexible) display 106A-B, such as a wraparound touch screen, the typing configurations discussed herein may work by having a person wearing the typing configuration use all five fingers on the one hand type text or otherwise navigate the typing configuration, such as by conceptually ‘playing one-handed piano’ on the touch screen of the wristband that she/he is wearing on their other hand. In an example use, the thumb may be placed on the control button 104A, the pinky on the control button 104B, and the index, middle and ring fingers on the character buttons 102A, 102B, and 102C, respectively.

An alternative arrangement of buttons that might be more convenient for one-handed typing and only using the thumb to select the characters on the character buttons 102D, 102E, and 102F (e.g., activate character buttons 102D-F) while using any two other fingers on the same hand to operate the control buttons 104C-D is shown in FIG. 2.

The typing configurations discussed herein may be implemented using only ‘virtual buttons’ on a touch screen but also using physical buttons or a combination of physical and virtual buttons. A virtual button may be a projection on a touch screen that defines an area within which button functionality is programmed to occur. The typing configurations discussed herein may be implemented by projecting outlines of areas onto a touch screen, wherein each outlined area indicates a character button 102A-L or a control button 104A-D.

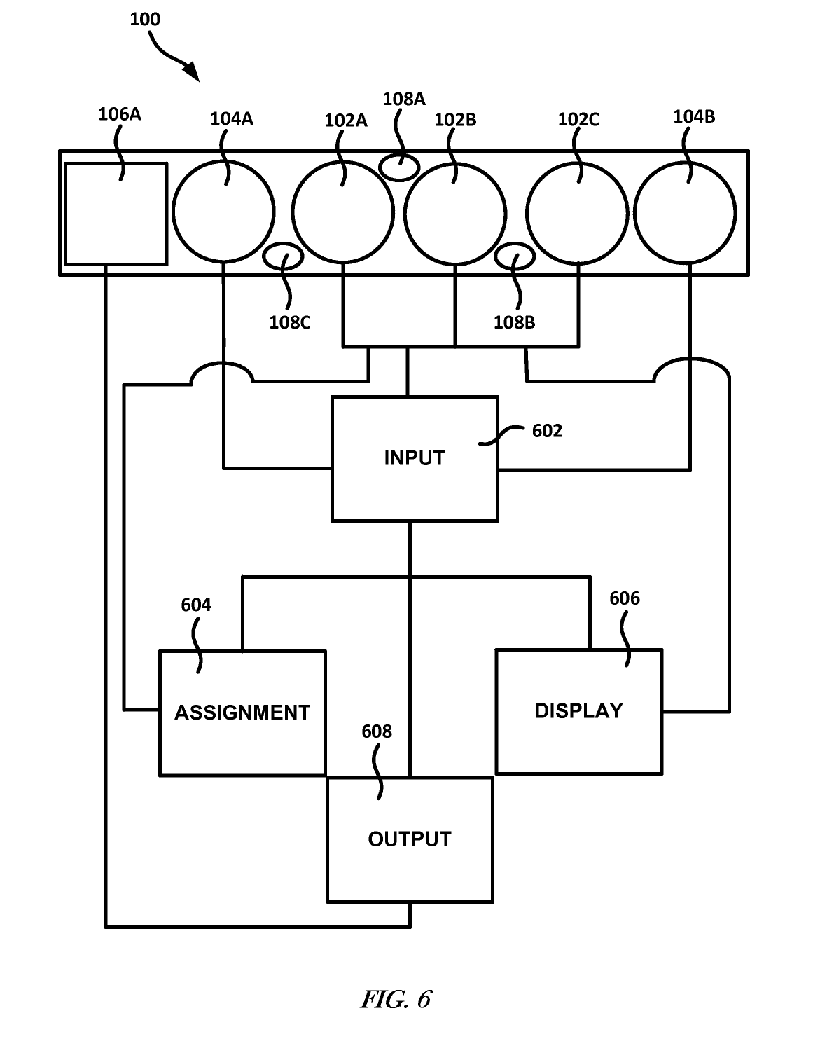

FIG. 6 shows an example of the typing configuration 100 coupled to processing circuitry. The processing circuitry may include an input module 602, an assignment module 604, a display module 606, or an output module 608. Other typing configurations discussed herein may be coupled to the processing circuitry.

The input module 602 may be configured to receive an input from a control button 104A-D. The input may indicate or change which sets of characters of a plurality of disjoint sets (two disjoint sets of characters do not include any of the same characters) of characters are to be assigned to the character buttons 102A-L, respectively. The input from the control button 104A-D may be received in response to a combination of the control button 104A-D and the character button 102A-L being activated at the same time, such as simultaneously. The input may indicate that an action, such as a QWERTY action, is to be output, such as through the output module 608, depending on the particular button(s) (e.g., character buttons 102A-C or control buttons 102A-B) held down, for example, as shown in FIG. 5.

The input module 602 may be configured to receive an input from a character button 102A-L. The input from the character button 102A-L may indicate which character of the set of characters assigned to that particular character button 102A-L to output (e.g., by the number of consecutive presses), such as by using the output module 608.

The assignment module 604 may be configured to assign a set of characters (e.g., a different set of characters) of a plurality of sets of characters (e.g., disjoint sets of characters) to each of the character buttons 102A-C on the typing configuration 100.

The display module 606 may be configured to project an assigned set of characters on a respective character button 102A-L. The projected sets of characters may indicate which character will be output after the respective character button is activated.

The output module 608 may be configured to transmit one or more signals representative of the character in response to the input from the character button 102A-L being received. The output module 608 may be configured to transmit one or more signals representative of the action in response to a character button 102A-L or control button 104A-D being activated, such as in combination. The output module 608 may be configured to transmit output signals to the display 106A-B. The output module 608 may be configured to transmit output signals to the display through a display driver, operating system, or other intermediary.

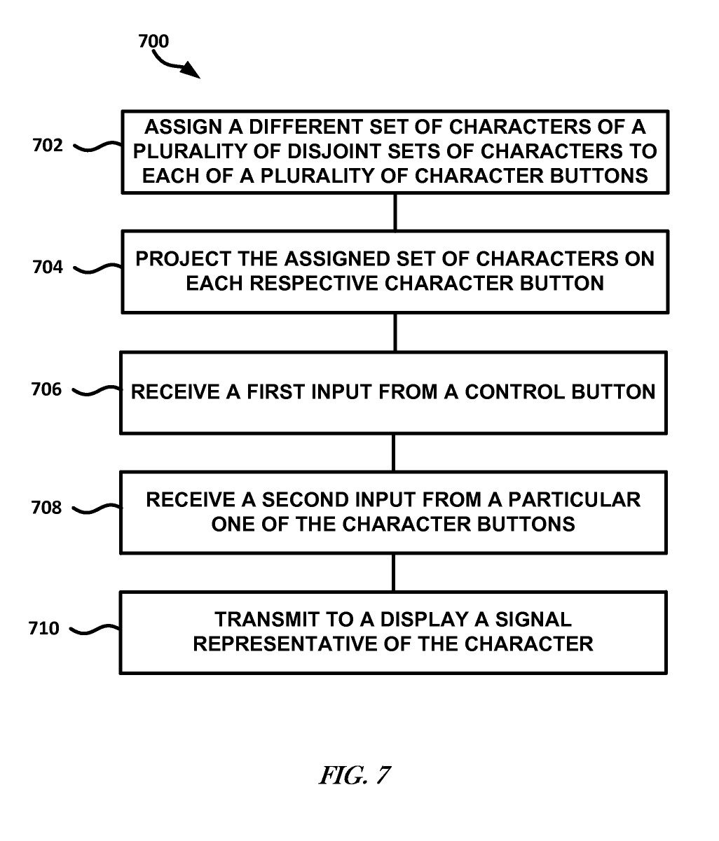

FIG. 7 illustrates a technique 700 of using a typing configuration. At 702, a different set of characters of a plurality of disjoint sets of characters may be assigned to each of a plurality of character buttons 102A-C. The plurality of character buttons 102A-C may be configured as a single row of a telephone keypad. The sets of characters may be assigned using the assignment module 604. At 704, one or more characters of the assigned set of characters may be projected on each respective character button 102A-C. The display module 606 may project the characters. The projected sets of characters may indicate which character will be output after the respective character button 102A-C is activated.

At 706, a first input may be received from a control button 104A-D. The first input may be received at the input module 602. The first input may indicate or change which sets of characters of the plurality of disjoint sets of characters are to be assigned to the three character buttons 102A-C, respectively. The technique 500 may include changing which row of the telephone keypad the plurality of character buttons 102A-C are configured as in response to receiving the first input. The first input may indicate that a different set of characters than the currently assigned set of characters is to be assigned to each of the character buttons 102A-C. The first input may be received in response to the control button 104A-B being pressed, or in some examples, swiped by a finger or a using performing some other hand gesture.

At 708, a second input from a character button 102A-C may be received. The second input may be received at the input module 602. The second input may indicate which character of the set of characters assigned to the particular key pressed to output.

At 710, one or more signals representative of the character may be transmitted, such as to the display 106A-B. The representative signal may be transmitted in response to the second input being received. The technique may include transmitting one or more signals representative of an action that is to be output. An output may be transmitted using the output module 608.

Transmitting the one or more signals representative of the character may include transmitting a signal representative of (1) a first character in the set of characters assigned to the particular character button in response to the particular character button being activated only once, (2) a second character in the set of characters assigned to the particular character button in response to the particular character button being activated twice without a specified period of time elapsing between activations, or (3) a third character in the set of characters assigned to the particular character button in response to the character button being activated three times without a specified period of time elapsing between activations. The first, second, and third characters may be different characters.

The technique 700 may include determining the location of a finger relative to a location of the control button 104A-B or the particular character button 102A-C using one or more bumps 108A-C situated near the control button 104A-B or the particular character button 102A-C, respectively. The technique 500 may include displaying the output on the display 106A, such as a touch screen display. The control button 104A-B and the character buttons 104A-C may each be displayed (e.g., projected onto) the display 106A at different locations on the touch screen.

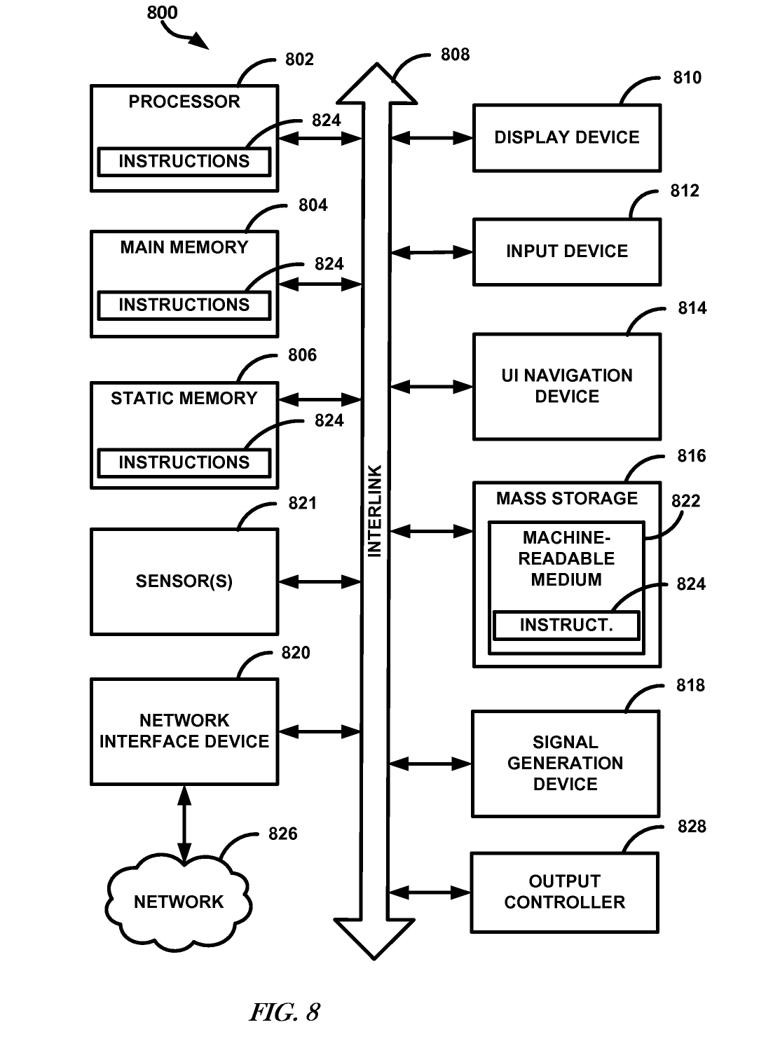

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### EXAMPLES AND NOTES

The present subject matter may be described by way of several examples.

Example 1 may include or use subject matter (such as an apparatus, a method, a means for performing acts, or a device readable memory including instructions that, when performed by the device, may cause the device to perform acts), such as can include or use a display, a plurality of character buttons and a control button, an assignment module configured to assign a particular set of characters of a plurality of disjoint sets of characters to each of the plurality of character buttons, each set of characters of the plurality of disjoint sets of characters including a plurality of characters, or a display module configured to display the assigned set of characters on each respective character button on the display. Example 1 may include or use an input module configured to receive a first input from the control button, the first input indicating a different set of characters of the plurality of disjoint sets of characters that are to be assigned to each of the plurality of character buttons, and the input module configured to receive a second input from a particular one of the plurality of character buttons. Example 1 may include or use an output module configured to transmit to the display a signal representative of one of the characters in the different set of characters in response to the second input being received. The display module of Example 1 may be configured to display the different set of characters that are assigned to each of the plurality of character buttons on each respective character button on the display.

Example 2 may include or use, or can optionally be combined with the subject matter of Example 1, to include or use wherein the output module is configured to transmit to the display a signal representative of one of the characters in the set of characters by being configured to transmit a signal representative of (1) a first character in the set of characters assigned to the particular character button in response to the particular character button being activated only once, (2) a second character in the set of characters assigned to the particular character button in response to the particular character button being activated twice without a specified period of time elapsing between activations, and (3) a third character in the set of characters assigned to the particular character button in response to the character button being activated three times without a specified period of time elapsing between activations, and wherein the first, second, and third characters are different characters.

Example 3 may include or use, or can optionally be combined with the subject matter of at least one of Examples 1-2, to include or use, wherein the plurality of character buttons are configured to replicate a single row of a telephone keypad and the control button is configured to change which row of the telephone keypad the plurality of character buttons are configured to replicate.

Example 4 may include or use, or can optionally be combined with the subject matter of at least one of Examples 1-3, to include or use, wherein the input module is configured to receive the first input in response to the control button being swiped by a finger.

Example 5 may include or use, or can optionally be combined with the subject matter of at least one of Examples 1-4, to include or use a bump situated near a character button of the plurality of character buttons or the control button, wherein the bump is configured to help a user determine the location of their finger relative to the location of the control or character button.

Example 6 may include or use, or can optionally be combined with the subject matter of at least one of Examples 1-5, to include or use, wherein each character button and control button is displayed at a different location on the touch screen.

Example 7 may include or use, or can optionally be combined with the subject matter of at least one of Examples 1-6, to include or use, wherein the output module is configured to transmit the output to the touch screen and wherein the touch screen is configured to display the character or action that the output is representative of.

Example 8 may include or use, or can optionally be combined with the subject matter of at least one of Examples 1-7, to include or use, wherein the control button is a first control button and the mobile device further comprises a second control button, wherein the plurality of character buttons is three character buttons displayed next to each other in a row on the display, wherein the first and second control buttons are in line with the row of three character buttons, wherein the first character button is on a first side of the row of three character buttons and the second control button is on a second side of the row of three character buttons, the second side opposite the first side, and wherein the display is in line with the row of character and control buttons.

Example 9 may include or use, or can optionally be combined with the subject matter of at least one of Examples 1-8, to include or use, wherein the bump is situated below and between two of the character buttons.

Example 10 may include or use, or can optionally be combined with the subject matter of at least one of Examples 1-7 or 9, to include or use, wherein the control button is a first control button and the mobile device further comprises a second control button, wherein the plurality of character buttons is three character buttons displayed next to each other in a row on the display, wherein the first and second control buttons are in line with the row of three character buttons, wherein the first and second control buttons are displayed directly next to each other and displayed on an end of the row of character buttons, and wherein the display is out of line with the row of character and control buttons.

Example 11 may include or use, or can optionally be combined with the subject matter of at least one of Examples 1-8 or 10, to include or use, wherein the bump is situated above and between two of the character buttons.

Example 12 may include or use, or can be optionally be combined with the subject matter of at least one of Examples 1-11, to include subject matter (such as an apparatus, a method, a means for performing acts, or a device readable memory including instructions that, when performed by the device, may cause the device to perform acts), such as may include or use assigning, using an assignment module, a particular set of characters of a plurality of disjoint sets of characters to each of a plurality of character buttons, each set of characters of the plurality of disjoint sets of characters including a plurality of characters, displaying, using a display module, the assigned set of characters on each respective character button on a display, or receiving, at an input module, a first input from a control button, the first input indicating a different set of characters of the plurality of disjoint sets of characters that are to be assigned to each of the plurality of character buttons. Example 12 may include or use receiving, at the input module, a second input from a particular one of the plurality of character buttons or transmitting to the display, using an output module, a signal representative of one of the characters in the different set of characters in response to the second input being received.

Example 13 may include or use, or can optionally be combined with the subject matter of at least one of Examples 1-12, to include or use receiving a third input indicating that a signal representative of an action to be performed on the display is to be output, the third input received in response to a combination of a character button and the control button being activated simultaneously, or transmitting the signal representative of the action.

Example 14 may include or use, or can optionally be combined with the subject matter of at least one of Examples 1-13, to include or use, wherein transmitting the one or more signals representative of one of the characters in the set of characters includes transmitting a signal representative of (1) a first character in the set of characters assigned to the particular character button in response to the particular character button being activated only once, (2) a second character in the set of characters assigned to the particular character button in response to the particular character button being activated twice without a specified period of time elapsing between activations, or (3) a third character in the set of characters assigned to the particular character button in response to the character button being activated three times without a specified period of time elapsing between activations, or wherein the first, second, and third characters are different characters.

Example 15 may include or use, or can optionally be combined with the subject matter of at least one of Examples 1-14, to include or use, wherein the plurality of character buttons are configured as a single row of a telephone keypad and the method further comprises changing which row of the telephone keypad the plurality of character buttons are configured as, in response to receiving the first input.

Example 16 may include or use, or can optionally be combined with the subject matter of at least one of Examples 1-15, to include or use, wherein receiving the first input includes receiving the first input in response to the control button being swiped by a finger.

Example 17 may include or use, or can optionally be combined with the subject matter of at least one of Examples 1-16, to include or use determining the location of a finger relative to a location of the control button or the particular character button using one or more bumps situated near the control button or the particular character button, respectively.

Example 18 may include or use, or can optionally be combined with the subject matter of at least one of Examples 1-17, to include or use, wherein the display is a touch screen and wherein the control button and the character buttons are each displayed at different locations on the touch screen.

Example 19 may include or use, or can optionally be combined with the subject matter of at least one of Examples 1-18, to include or use, displaying the output on the touch screen.

Example 20 may include or use, or can optionally be combined with the subject matter of at least one of Examples 1-19, to include or use a machine-readable medium including instructions for controlling a touchscreen display and a secondary display from the touchscreen display, which when executed by a machine, cause the machine to perform operations of any of Examples 12-19.

Example 20 may include or use, or can optionally be combined with the subject matter of at least one of Examples 1-19, to include or use an apparatus comprising means for performing any of the Examples 12-19.

The above Description of Embodiments includes references to the accompanying drawings, which form a part of the detailed description. The drawings show, by way of illustration, specific embodiments in which methods, apparatuses, and systems discussed herein may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

The flowchart and block diagrams in the FIGS. illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The functions or techniques described herein may be implemented in software or a combination of software and human implemented procedures. The software may consist of computer executable instructions stored on computer readable media such as memory or other type of storage devices. The term “computer readable media” is also used to represent any means by which the computer readable instructions may be received by the computer, such as by different forms of wired or wireless transmissions. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

As used herein, a “-” (dash) used when referring to a reference number means “or”, in the non-exclusive sense discussed in the previous paragraph, of all elements within the range indicated by the dash. For example, 103A-B means a nonexclusive “or” of the elements in the range {103A, 103B}, such that 103A-103B includes “103A but not 103B”, “103B but not 103A”, and “103A and 103B”.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Description of Embodiments, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Description of Embodiments as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1-25. (canceled)

26. A machine readable storage device including instructions stored thereon, the instructions, which when executed by a machine, cause the machine to perform operations comprising:
assigning a particular set of characters of a plurality of disjoint sets of characters to each of a plurality of character buttons, each set of characters of the plurality of disjoint sets of characters including a plurality of characters;
displaying the assigned set of characters on each respective character button on a display;
receiving a first input from a control button, the first input indicating that a different set of characters of the plurality of disjoint sets of characters are to be assigned to each of the plurality of character buttons;
receiving a second input from a particular one of the plurality of character buttons; and
transmitting to the display a signal representative of one of the characters in the different set of characters in response to the second input being received.

27. The storage device of claim 26, further comprising instructions, which when executed by the machine, cause the machine to perform operation further comprising:
receiving a third input indicating that an action to be performed on the display is to be output, the third input received in response to a combination of a character button and the control button being activated simultaneously; and
transmitting the signal representative of the action.

28. The storage device of claim 27, wherein the instructions for transmitting a signal representative of one of the characters in the different set of characters of the plurality of disjoint sets of characters assigned to the particular one of the plurality of character buttons in response to the second input being received include instructions, which when performed by the machine, cause the machine to transmit a signal representative of:
a first character in the different set of characters assigned to the particular character button in response to the particular character button being activated only once;
a second character in the different set of characters assigned to the particular character button in response to the particular character button being activated twice without a specified period of time elapsing between activations; and
a third character in the different set of characters assigned to the particular character button in response to the character button being activated three times without a specified period of time elapsing between activations; and
wherein the first, second, and third characters are different characters.

29. The storage device of claim 28, wherein the character buttons are configured as a row of a telephone keypad and the instructions further comprise instructions, which when executed by the machine, cause the machine to further perform operations comprising changing which row of the telephone keypad the plurality of character buttons are configured as in response to receiving the first input.

30-32. (canceled)

33. A mobile device comprising:
a display;
a plurality of character buttons and a control button;
an assignment module configured to assign a particular set of characters of a plurality of disjoint sets of characters to each of the plurality of character buttons, each set of characters of the plurality of disjoint sets of characters including a plurality of characters;
a display module configured to display the assigned set of characters on each respective character button on the display;
an input module configured to receive a first input from the control button, the first input indicating a different set of characters of the plurality of disjoint sets of characters that are to be assigned to each of the plurality of character buttons, and the input module configured to receive a second input from a particular one of the plurality of character buttons; and
an output module configured to transmit to the display a signal representative of one of the characters in the different set of characters in response to the second input being received; and
wherein the display module is configured to display the different set of characters that are assigned to each of the plurality of character buttons on each respective character button on the display.

34. The mobile device of claim 33, wherein:
the output module is configured to transmit to the display a signal representative of one of the characters in the different set of characters by being configured to transmit a signal representative of:
a first character in the different set of characters assigned to the particular character button in response to the particular character button being activated only once;
a second character in the different set of characters assigned to the particular character button in response to the particular character button being activated twice without a specified period of time elapsing between activations; and
a third character in the different set of characters assigned to the particular character button in response to the character button being activated three times without a specified period of time elapsing between activations; and
wherein the first, second, and third characters are different characters.

35. The mobile device of claim 34, wherein the plurality of character buttons are configured to replicate a single row of a telephone keypad and the control button is configured to change which row of the telephone keypad the plurality of character buttons are configured to replicate.

36. The mobile device of claim 35, wherein the input module is configured to receive the first input in response to the control button being swiped by a finger.

37. The mobile device of claim 36, further comprising a bump situated near a character button of the plurality of character buttons or the control button, wherein the bump is configured to help a user determine the location of their finger relative to the location of the control or character button.

38. The mobile device of claim 37, further comprising a touch screen, wherein each character button and control button is displayed at a different location on the touch screen.

39. The mobile device of claim 38, wherein the output module is configured to transmit the output to the touch screen and wherein the touch screen is configured to display the character or action that the output is representative of.

40. The mobile device of claim 39, wherein the control button is a first control button and the mobile device further comprises a second control button, wherein the plurality of character buttons is three character buttons displayed next to each other in a row on the display, wherein the first and second control buttons are in line with the row of three character buttons, wherein the first character button is on a first side of the row of three character buttons and the second control button is on a second side of the row of three character buttons, the second side opposite the first side, and wherein the display is in line with the row of character and control buttons.

41. The mobile device of claim 40, wherein the bump is situated below and between two of the character buttons.

42. The mobile device of claim 41, wherein the control button is a first control button and the mobile device further comprises a second control button, wherein the plurality of character buttons is three character buttons displayed next to each other in a row on the display, wherein the first and second control buttons are in line with the row of three character buttons, wherein the first and second control buttons are displayed directly next to each other and displayed on an end of the row of character buttons, and wherein the display is out of line with the row of character and control buttons.

43. The mobile device of claim 42, wherein the bump is situated above and between two of the character buttons.

44. A method comprising:
assigning, using an assignment module, a particular set of characters of a plurality of disjoint sets of characters to each of a plurality of character buttons, each set of characters of the plurality of disjoint sets of characters including a plurality of characters;
displaying, using a display module, the assigned set of characters on each respective character button on a display;
receiving, at an input module, a first input from a control button, the first input indicating a different set of characters of the plurality of disjoint sets of characters that are to be assigned to each of the plurality of character buttons;
receiving, at the input module, a second input from a particular one of the plurality of character buttons; and
transmitting to the display, using an output module, a signal representative of one of the characters in the different set of characters in response to the second input being received.

45. The method of claim 44, further comprising:
receiving a third input indicating that a signal representative of an action to be performed on the display is to be output, the third input received in response to a combination of a character button and the control button being activated simultaneously; and
transmitting the signal representative of the action.

46. The method of claim 45, wherein transmitting the signal representative of one of the characters in the different set of characters includes transmitting a signal representative of:
a first character in the different set of characters assigned to the particular character button in response to the particular character button being activated only once;
a second character in the different set of characters assigned to the particular character button in response to the particular character button being activated twice without a specified period of time elapsing between activations; and
a third character in the different set of characters assigned to the particular character button in response to the character button being activated three times without a specified period of time elapsing between activations; and
wherein the first, second, and third characters are different characters.

47. The method of claim 46, wherein the plurality of character buttons are configured as a single row of a telephone keypad and the method further comprises changing which row of the telephone keypad the plurality of character buttons are configured as, in response to receiving the first input.

48. The method of claim 47, wherein receiving the first input includes receiving the first input in response to the control button being swiped by a finger.

49. The method of claim 48, further comprising determining the location of a finger relative to a location of the control button or the particular character button using one or more bumps situated near the control button or the particular character button.

50. The method of claim 49, wherein the display is a touch screen and wherein the control button and the character buttons are each displayed at different locations on the touch screen.
